(19) United States
(12) Patent Application Publication
(10) Pub. No.: US 2018/0167719 A1
(43) Pub. Date: Jun. 14, 2018

(54) SPEAKER

(71) Applicant: O2Aid, INC., Takasaki-shi (JP)

(72) Inventors: Akihiko HOSAKA, Tokyo (JP); Yoshiyuki WATANABE, Takasaki-shi (JP)

(21) Appl. No.: 15/576,869

(22) PCT Filed: May 29, 2016
(86) PCT No.: PCT/JP2016/065843

§ 371 Date: Nov. 27, 2017

(30) Foreign Application Priority Data
May 31, 2015 (JP) 2015-110987

(51) Int. Cl. H04R 1/24; H04R 17/10; H04R 1/26; H04R 9/06

(52) U.S. Cl. CPC H04R 1/24; H04R 17/10; H04R 2201/028; H04R 9/06; H04R 1/26

(57) ABSTRACT

A speaker which drives a dynamic speaker with one amplifier is provided which has an excellent frequency characteristic. This speaker 3 is provided with a dynamic speaker 2, a piezoelectric speaker 3, and one current amplifier 4 which drives both the dynamic speaker 2 and the piezoelectric speaker 3. Defining Zd as the rated impedance of the dynamic speaker 2 and Zp(ω) as the impedance of the piezoelectric element 31, by stipulating that the frequency values ω at which Zd=Zp(ω) are 20-50 kHz, a superior high-range frequency characteristic is achieved.

### TECHNICAL FIELD

The present invention relates to a speaker.

### BACKGROUND ART

Known types of speakers used in earphones and the like include a piezoelectric element-type speaker and a dynamic speaker, as disclosed in Patent Reference 1.

In a dynamic speaker, since the voice coil is driven by a current, a current amplifier is needed. On the other hand, since in the case of a piezoelectric element the displacement is proportional to the voltage, a voltage amplifier is required to drive it. Because of this, two amplifiers must be provided, making it far from easy to use such speakers in earphones and other similar small devices.

Current drive of a piezoelectric element is possible but the following problems remain. The variation of the impedance of a piezoelectric element depends on frequency. Thus, even if the same current is supplied, the voltage applied to the piezoelectric element changes depending on the frequency, and, thus, the displacement of the piezoelectric element also changes. It is thus difficult to achieve flat frequency response characteristics. Because of this, it is usually driven by a voltage drive type amplifier but the requirement for a booster circuit means that this is costly and there is also a necessity for a mounting surface area large enough for a boost inductor.

Conversely, when a dynamic speaker is driven by a piezoelectric drive amplifier, the voltage is too high and the coil disconnects. Even if the coil is made thicker such that the breakdown voltage characteristics of the coil are increased, the impedance becomes too low and an sufficient voltage cannot be applied. Similarly, if the impedance is increased by adding to the number of turns in the coil, this inevitably results in increases in the size and cost of the dynamic speaker.

Due to this, it has not been possible to develop a speaker in which a dynamic speaker and piezoelectric speaker are driven by a single amplifier. The use of two amplifiers results in a further increase in the mounting surface area.

### PRIOR ART REFERENCES

### Patent References

Patent Reference 1: JP 2004-147077 (A).

### SUMMARY OF THE INVENTION

### Problem the Invention Aims to Solve

The present invention has the object of providing a speaker in which a dynamic speaker and piezoelectric speaker are driven by a single amplifier and which has excellent frequency response characteristics.

### Means by Which the Problem is Solved

The speaker according to the invention is characterised in that it is furnished with a dynamic speaker and piezoelectric speaker and one current amplifier that drives both the said dynamic speaker and said piezoelectric speaker.

With such characteristics, it is possible to drive both the dynamic speaker and the piezoelectric speaker with a single current amplifier.

The speaker according to the invention is characterised in that, when a frequency of an output sound is ω, a rated impedance of the said dynamic speaker is Zd, and the impedance of the piezoelectric element used in the said piezoelectric speaker is Zp (ω), the value of ω such that Zd=Zp(ω) is 20˜50 kHz.

With such a characteristic, it is possible to output from the piezoelectric speaker the part of the sound that is higher in frequency than the vicinity of the crossover point (the value of ω such that Zd=Zp(ω)). The dynamic speaker cannot be caused to output a high-frequency sound.

The speaker according to the invention is characterised in that the capacitance of the said piezoelectric element is at least 200 nF.

With such a characteristic, it is possible for the frequency of the crossover point to be lowered.

With the present invention, it is possible to provide a speaker in which a dynamic speaker and piezoelectric speaker are driven by a single amplifier and which has excellent frequency response characteristics.

### SIMPLE DESCRIPTION OF THE INVENTION

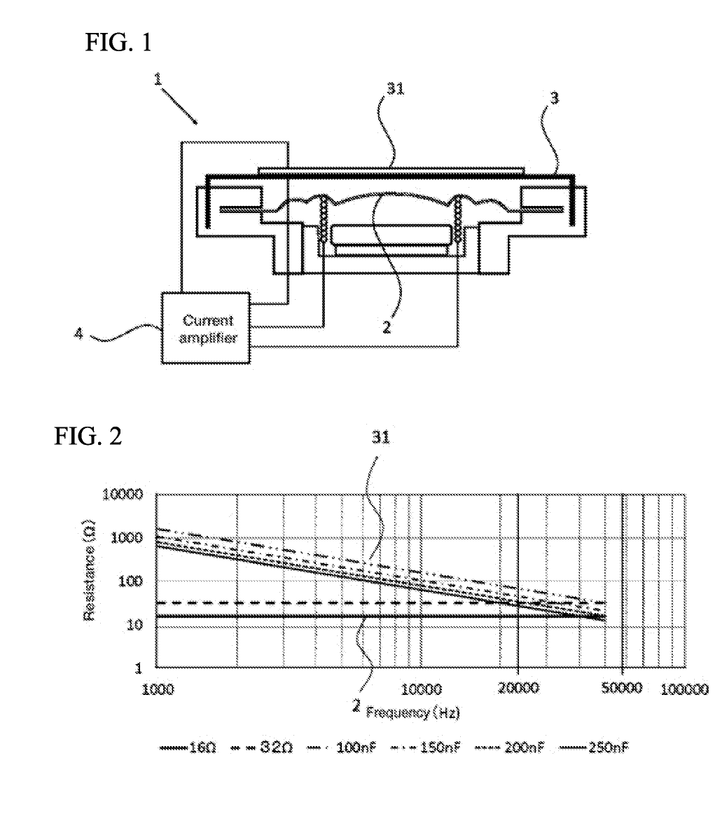

FIG. 1 A figure showing the speaker according to the invention.

FIG. 2 A figure showing the impedances of the dynamic speaker and piezoelectric speaker.

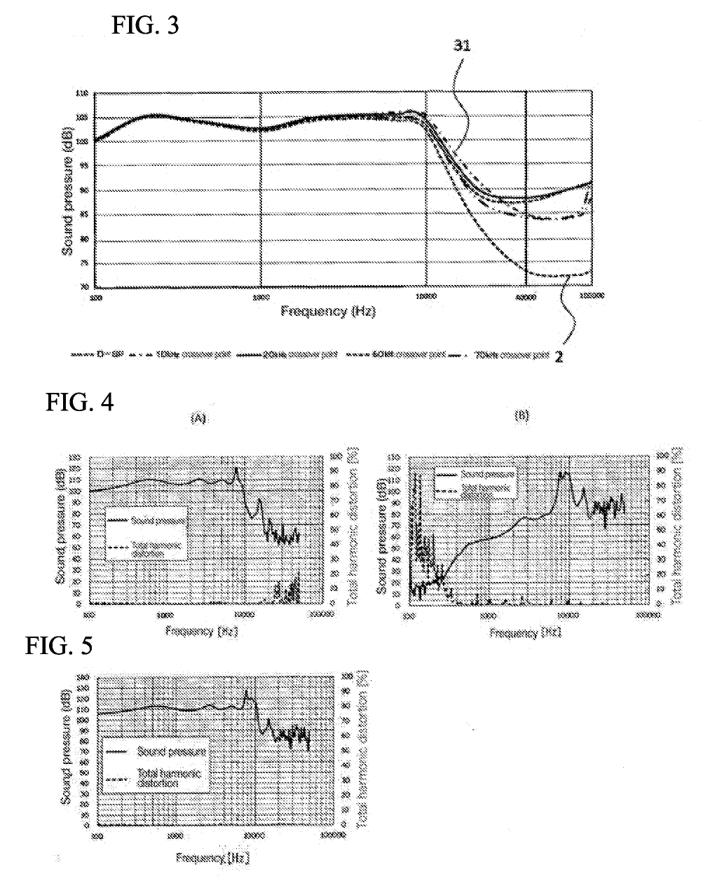

FIG. 3 A figure showing the frequency response characteristics.

FIG. 4 A figure showing the frequency response characteristics and distortion factor.

FIG. 5 A figure showing the frequency response characteristics and distortion factor.

Embodiment 1, which shows the operating principles of the invention and Embodiment 2, which shows specific implementations, are described below.

### EMBODIMENT 1

The speaker according to the invention is shown in FIG. 1. Speaker 1 is furnished with a dynamic speaker 2, piezoelectric speaker 3 and a single current amplifier, which drives both the dynamic speaker 2 and piezoelectric speaker 3. In the piezoelectric speaker 3, a piezoelectric element 31 is applied to a metal sheet.

FIG. 2 shows the impedances of the dynamic speaker and piezoelectric element. The horizontal axis shows frequency and the vertical axis is impedance. Both frequency and impedance are logarithmic scale. The rated impedance Zd of the dynamic speaker 2 is a constant in the range 16˜32Ω; 16Ω is shown by a solid line and 32Ωby a broken line. The impedance of the dynamic speaker is a fixed value for the rated impedance in the central frequency band. Impedance rises in the low-frequency range and high-frequency range frequencies but in the present invention in which the high-frequency range is output to the piezoelectric speaker, the rated impedance may be considered to be a fixed value.

As shown in the figure, the impedance Zp (ω) of the piezoelectric element 31 is linear, sloping downward to the right. The vertical variation of Zp (ω) depends on the capacitance of the piezoelectric element 31. A capacitance of 250 μF is shown by a solid line, a capacitance of 200 μF is shown by a broken line, a capacitance of 150 μF is shown by a single-dotted broken line and a capacitance of 100 μF is shown by a double-dotted broken line.

In light of the value of the frequency ω at which Zd and Zp(ω) cross over, when the capacitance =250 μF and Zd=32Ω, crossover point occurs at approximately 20 kHz, while capacitance =250 μF and Zd=16Ω, crossover point occurs at approximately 40 kHz. When the capacitance =200 μF and Zd=32Ω, crossover point occurs at approximately 25 kHz, while the capacitance =200 μF and Zd=16Ω, crossover point occurs at approximately 50 kHz. When the capacitance =150 μF and Zd=32Ω, crossover point occurs at approximately 33 kHz, while the capacitance =150 μF and Zd=16Ω, crossover point occurs at approximately 66 kHz (this crossover is not shown in the figure). When the capacitance =100 μF and Zd=32Ω, crossover point occurs at approximately 50 kHz, and the capacitance =100 μF and Zd=16Ω, crossover point occurs at approximately 100 kHz (this crossover is not shown in the figure). The greater the capacitance, the lower the frequency at which crossover occurs. When the capacitance is 200 μF or greater, the frequency at which crossover with Zd=16Ωtakes place is no higher than 50 kHz.

For the crossover point to be at a low frequency, it is preferable that the capacitance of the piezoelectric element 31 should be large. It is possible to increase the capacitance by, for example, using a laminated piezoelectric element or MEMS element as the piezoelectric element 31.

FIG. 3 shows the frequency response characteristics. The frequency response characteristics of the dynamic speaker 2 are indicated by the number 2. The sound pressure at high ranges of 10 kHz and above by the dynamic speaker 2 alone is insufficient. In particular, the sound pressure at 40 kHz or above, which is essential for the sound quality referred to as high-resolution, is very low.

The frequency characteristics combining the dynamic speaker 2 and piezoelectric speaker 3 are indicated by the number 31. Since the frequency response characteristics vary dependent on the crossover point, a crossover point at 10 kHz is shown by a single-dotted broken line, one at 20 kHz by a solid line, one at 50 kHZ by a broken line and one at 70 kHz by a double-dotted broken line.

Crossover points at 20 kHz and 50 kHz are frequency response characteristics at which sound pressure is sufficient in the range 40 kHz˜100 kHz. By contrast, sufficient sound pressure cannot be achieved with crossover points at 10 kHz and 70 kHz.

Since the frequency response characteristics vary continuously against the crossover point, if the frequency at the crossover point is 20˜50 kHz, it is possible to obtain frequency response characteristics such that there is sufficient sound pressure in a range 40 kHz˜100 kHz.

As described in detail above, this embodiment of the speaker is driven by a single current amplifier 4, which makes it suitable for size reduction. Also, if the crossover point frequency is 20˜50 kHz, it is possible to achieve an sufficient sound pressure, and thus to achieve high-resolution sound reproduction in a range of 40 kHz˜100 kHz.

### EMBODIMENT 2

The speaker is constituted as described below. A 6 μm thick, 10 mm diameter, circular PET diaphragm is used as the dynamic speaker 2. The rated impedance Zd of the dynamic speaker 2 is 32Ω. Five layers of lead zirconate titanate (PZT) piezoelectric elements 31 laminated onto a stainless steel (SUS304) 10 mm diameter circular diaphragm are used as the piezoelectric speaker 3. The capacitance of the piezoelectric elements 31 is 150nF. The crossover frequency is approximately 33 kHz (see FIG. 2).

FIG. 4 shows the frequency response characteristic and distortion. FIG. 4(A) shows the dynamic speaker 2. Sound pressure decreases at a high frequency of 10 kHz and above. Distortion is also increased at a high frequency of 20 kHz and higher.

FIG. 4(B) shows piezoelectric speaker 3. Sound pressure decreases at a low frequency of 2 kHz and below. Distortion is also increased at a low frequency of 400 Hz and lower.

The dynamic speaker 2 and piezoelectric speaker 3 are both driven by a single current amplifier (at the same output strength for both the dynamic speaker 2 and piezoelectric speaker 3). FIG. 5 shows the frequency response characteristics and distortion. This shows flatter frequency response characteristics than FIGS. 4(A) and (B). It is a particularly important point that the sound pressure does not decrease at 40 kHz and above (shown as 40˜50 kHz in the figure).

In terms of distortion, since the sound pressure of the dynamic speaker 2 increases in the low frequency range and the sound pressure of the piezoelectric speaker 3 increases in the high frequency range, there is low distortion at both of these frequencies.

As described in detail above, in this embodiment of the speaker, sufficient sound pressure is obtained and low distortion achieved at a high frequency range of 40 kHz and above.

### INDUSTRIAL APPLICABILITY

This is a speaker with high sound quality which is readily miniaturised and which may find applications with a wide range of audio equipment manufacturers.

### LEGEND

1 Metal sheet
2 Dynamic speaker
3 Piezoelectric speaker
31 Piezoelectric element
4 Current amplifier

1. A speaker characterised in that it is furnished with
a dynamic speaker and
piezoelectric speaker and
one current amplifier that drives both the said dynamic speaker and said piezoelectric speaker.

2. A speaker, according to claim 1, characterised in that, when a frequency of an output sound is ω, the rated impedance of the said dynamic speaker is Zd and the impedance of the piezoelectric element used in the said piezoelectric speaker is Zp(ω), when Zd =ZP(ω) the value of ω is 20˜50 kHz.

3. A speaker, according to claim 2, characterised in that the capacitance of said piezoelectric element is at least 200 nF.
